(19) United States
(12) Patent Application Publication
(10) Pub. No.: US 2008/0125122 A1
(43) Pub. Date: May 29, 2008

(54) Resource management method for multiple services in a heterogeneous network

(75) Inventors: Yong- Xing Zhou, Yongin-si (KR); Jianjun Li, Yongin-si (KR); Hao Chen, Beijing (CN); Zhigang Cao, Beijing (CN); Pingyi Fan, Beijing (CN); Won-Hyoung Park, Seoul (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); TSINGHUA UNIVERSITY, Beijing (CN)

(21) Appl. No.: 11/475,806

(22) Filed: Jun. 27, 2006

(30) Foreign Application Priority Data
Jun. 27, 2005 (KR) 2005-55982

(51) Int. Cl. H04Q 7/20; G06F 17/30

(52) U.S. Cl. 455/436; 455/405; 705/10

(57) ABSTRACT

Provided is a method in which a subscriber can receive a desired service at the lowest price in a heterogeneous network and a network provider can maximize its own revenue according to situation. A handoff to a target cell for a terminal is performed by considering a handoff probability as well as resource prices in current and target cells. In cells configuring the heterogeneous network, optimal resource price for each service is computed on the basis of demand and supply resources. An arrived call from the terminal is processed using the computed resource price.

### PRIORITY

This application claims priority under 35 U.S.C. § 119 to an application entitled “Resource Management Method For Multiple Services in A Heterogeneous Network” filed in the Korean Intellectual Property Office on Jun. 27, 2005 and assigned Serial No. 2005-55982, the contents of which are incorporated herein by reference.

### BACKGROUND OF THE INVENTION

1. Field of the Invention

The present invention relates generally to a method for providing multiple services in a heterogeneous network, and in particular to a resource management method for providing multiple services.

2. Description of the Related Art

In light of the development of communication technology, presently a mobile communication system provides a service for transmitting a large amount of data including, but not limited to, packet data and circuit data, as well for as a voice service. Furthermore, the mobile communication system is developing into a multimedia broadcasting/communication system capable of transmitting multimedia services.

Research is actively being conducted on various communication systems for providing users with services based on various Qualities of Service (QoS) requiring a high transmission rate. Thus, it will be obvious that heterogeneous networks co-exist when various communication systems are commercialized.

A handoff between heterogeneous networks should be basically supported such that a terminal can receive an optimal service in a heterogeneous network. Also, the terminal should be able to select a cell in which it can use a desired service at the lowest price in an area where various cells are present. This can be equally applied for a new call as well as the handoff.

On the other hand, a method should be provided in which a network provider can provide an optimal service to terminals as well as maximize its own revenue.

Conventionally, in the heterogeneous network only QoS for a handoff is considered. That is, execution of a handoff to another cell occurs only when the QoS received by a terminal is less than a predetermined level. However, if the price of resources in another cell is lower notwithstanding that the QoS is maintained in at least the predetermined level, the handoff to the other cell can to be attempted for the terminal. In order to support this, the foundation technology needs be provided in a network.

Furthermore, to satisfy a subscriber request in the network, the optimal price should be able to be computed and advertised according to situations on a service-by-service basis.

### SUMMARY OF THE INVENTION

Therefore, the present invention provides a method that can select an optimal cell in a heterogeneous network.

Moreover the present invention provides a method that can decide a handoff for a terminal by considering resource prices in current as well as target cells.

The present invention provides a method that can perform a handoff by considering resource prices in current and target cells as well as a handoff probability defined by service characteristics.

Furthermore, the present invention provides a method that can select resource prices for each service by considering supply and demand resources.

Still further, the present invention provides a method that can optimize resource prices according to variation in demand resources for each service.

Additionally, the present invention provides a method that can determine whether to admit a new call or a handoff call by considering resource prices.

In accordance with an aspect of the present invention, in a terminal of a heterogeneous network, there is provided a method for processing a call including measuring strengths of signals received from cells configuring the heterogeneous network and setting candidate cells; selecting a candidate cell in which lowest resource price is required for new service traffic from among the candidate cells when the new service traffic is requested, and transmitting a request for a new call to the selected candidate cell; and computing a resource price difference ratio between a cell currently providing service traffic and each candidate cell when a handoff is requested for the service traffic in progress, and transmitting a handoff request to one of the candidate cells using the difference ratio and a probability based on characteristics of the service traffic.

In accordance with another aspect of the present invention, in cells configuring a heterogeneous network, there is provided a method for deciding resource prices on a service-by-service basis, including computing initial resource price by averaging initial upper and lower bound resource prices defined for each service; updating the upper bound resource price to current resource price when demand resources are less than supply resources, and updating the current resource price using the updated upper bound resource price; updating the lower bound resource price to the current resource price when the demand resources are at least equal to the supply resources, and updating the current resource price using the updated lower bound resource price; and setting the current resource price to optimal resource price when the demand and supply resources are balanced by the updated current resource price.

In accordance with still another aspect of the present invention, in cells configuring a heterogeneous network, there is provided a method for processing a call, including computing temporary resource price under assumption that an arrived call has been admitted; admitting the arrived call when current resource price is less than the temporary resource price; and rejecting the arrived call when the current resource price is more than the temporary resource price, wherein when multiple calls have arrived at an identical time, a call with a lower priority is rejected among the multiple calls and admission of the remaining arrived calls is decided.

### BRIEF DESCRIPTION OF THE DRAWINGS

The above and other features, advantages, and aspects of the present invention will be more clearly understood from the following detailed description taken in conjunction with the accompanying drawings, in which:

FIG. 1 illustrates a mobile communication system of a heterogeneous network to which the present invention is applied;

FIG. 2 is a flow chart illustrating a control flow for processing a call in a terminal of a heterogeneous network in accordance with the present invention;

FIG. 3 is a flow chart illustrating a control flow for deciding optimal resource price in a network in accordance with the present invention; and

FIG. 4 is a flow chart illustrating a control flow for call admission control in a heterogeneous network in accordance with the present invention.

### DETAILED DESCRIPTION OF THE PREFERRED EMBODIMENTS

Preferred embodiments of the present invention will now be described in detail with reference to the accompanying drawings. In the following description, a detailed description of known function and configurations incorporated herein has been omitted for clarity and conciseness.

The present invention provides a method in which a subscriber can receive a desired service at the lowest price in a heterogeneous network and a network provider can maximize its own revenue according to given situation. For this, there should be considered characteristics of each network configuring the heterogeneous network and characteristics of a service provided from the heterogeneous network.

Each service of the services provided from the heterogeneous network that are classified, for example, into a voice service, a data service, and a video service, has unique characteristics. That is, the voice service has the same utility at a predetermined data rate or greater. Thus, only resources for supporting the predetermined data rate can be assigned for the voice service. As the data rate increases in the case of the data service, the utility also increases. As the data rate increases in a predetermined range in the case of the video service, the utility abruptly increases, but does not vary at other data rates.

Equation (1) set forth below can be considered for optimizing a transmission rate for each service type.

$${max}_{{R}_{s}} {\sum }_{s = 1}^{R} {N}_{s} \times {U}_{s} ( {R}_{s} ) \\ s . t . {\sum }_{s = 1}^{s} {N}_{s} \times {R}_{s} \leq R \qquad ( 1 )$$

In Equation (1), s (=1 . . . S) is a type of service traffic, Nₛ is the number of subscribers in each type of service traffic, Rₛ is an average transmission rate mapped to each type of service traffic, and R is the total system capacity, and Uₓ(Rₛ) is the utility in each type of service traffic.

In order to satisfy the above-described condition, resource price and a resource allocation level capable of maximizing a transmission rate for each service should be optimal. This can be defined as shown in Equation (2) as set forth below.

$${\sum }_{s = 1}^{S} {N}_{s} \times {R}_{s} = R \qquad ( 2 )$$

In Equation (2), the product of the number of subscribers and an allocation resource amount is computed with respect to each service. The resource price is computed at which a sum of all products corresponds to the maximum resources available in the network.

In order to maximize the revenue in the network, the conditions of Equations (3-5) are considered.

$$\frac{\partial {B}_{s} ( {R}_{s} , p )}{\partial {R}_{s}} = 0 \qquad ( 3 )$$

In Equation (3), a ratio of a partial differential for the revenue in each service and a partial differential for an amount of resources provided for each service can to be balanced. As a result, Equation (3) as set forth above means that U′ₓ(Rₛ)−p=0.

Second, an amount of demand resources and an amount of supply resources can be balanced by arbitrary resource price defined for each service. This can be defined as shown in Equation (4) as set forth below.

Dₓ(p)=Rₛ(p) (4)

Third, the service cannot be provided when the resource price defined for each service exceeds the maximum resource price desired by the terminal. This can be defined as shown in Equation (5) as set forth below.

Dₓ(p)=0 ∀p≧pₛₘₐₓ (5)

Resource allocation for the terminal is interrupted when the resource price p set in a cell for a particular service exceeds the maximum resource price pₛₘₐₓ predefined to receive the service in Equation (5). Thus, it is preferred that the resource price for each service is set such that demand and supply resources are balanced.

An operation for processing a call in a terminal by considering resource price and a service type in a heterogeneous network will be described below in detail with reference to the preferred embodiments of the present invention. Also, an operation for deciding optimal resource price by considering an arrived call from a terminal in a network and an operation for processing the arrived call will be described in detail.

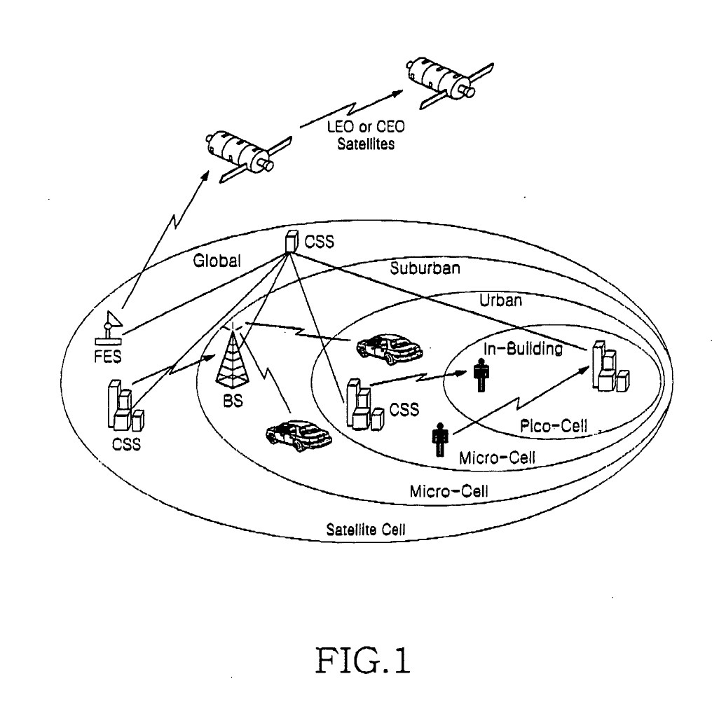

FIG. 1 illustrates a mobile communication system of a heterogeneous network to which the present invention is applied.

As illustrated in FIG. 1, the heterogeneous network is configured with a pico-cell, micro-cell, macro-cell, and satellite cell. Bluetooth and so on are present in the pico-cell. A wireless Local Area Network (LAN) and so on are present in the micro-cell. Asynchronous or synchronous networks are present in the macro-cell. Low Earth Orbit (LEO) or Geostationary Earth Orbit (GEO) satellites and so on are present in the satellite cell.

A terminal located in an area where multiple cells overlap can select one cell to receive a desired service from the selected cell. In a state in which the terminal receives a service from a currently accessed cell, a handoff to another cell can be performed. For example, the terminal can request a handoff to the micro-cell while accessing the pico-cell. Of course, the terminal can be located in an area where the pico and micro-cells can transmit a service. On the other hand, as the terminal moves to the pico-cell while receiving a service from the micro-cell, it is possible to handoff to the pico-cell. Thus, when the terminal is located in the area where the service can be received from the multiple cells, it can select a cell where a desired service is optimal.

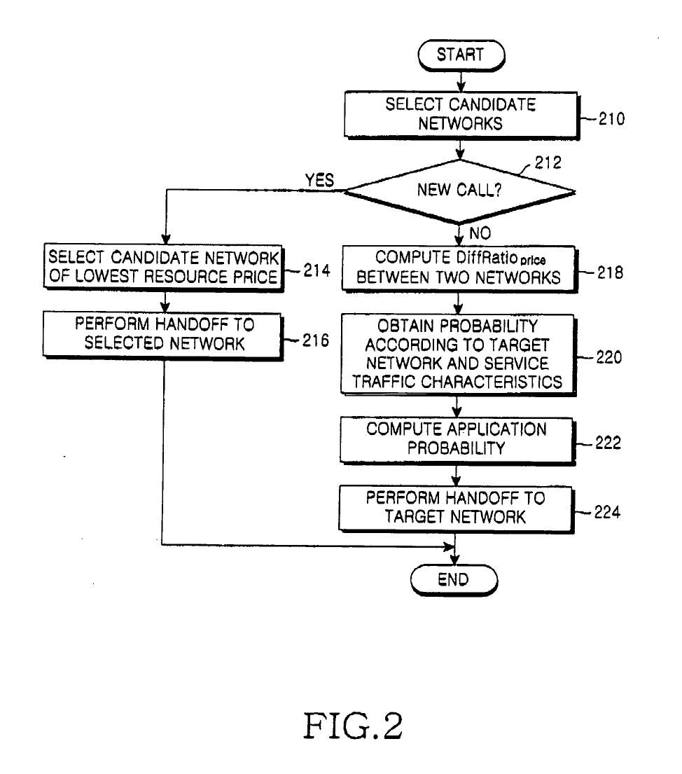

FIG. 2 is a flowchart illustrating a control flow for processing a call in a terminal of a heterogeneous network in accordance the present invention. In the control flow of FIG. 2, a new call and a handoff call are divided and processed. For the new call, a cell where the price of resources to be used is lowest is selected from among candidate cells where a service is possible. For the handoff call, a handoff to a cell with the highest handoff probability among candidate cells where the handoff is possible is performed.

Referring to FIG. 2, the terminal selects candidate cells in step 210. The terminal measures strengths of signals received from cells configuring the heterogeneous network and selects the candidate cells relative to received signal strengths exceeding a preset threshold.

In step 212, the terminal determines whether access to an arbitrary cell is made by a new call or a handoff call. The new call indicates an attempt for initial cell access in a state in which access to any cell is previously absent. The handoff call indicates a new attempt for accessing another cell in a state in which access to a specific cell is currently present.

Upon determining that the access is made by the new call, the terminal reviews resource prices in the candidate cells and selects a cell of the lowest resource price in step 214. The resource price is the price to use resources required to receive a desired service in the terminal. The resource price can differ according to cells on a service-by-service basis. Thus, the terminal selects a cell for providing a desired service at the lowest price. When selecting a cell of the lowest resource price, the terminal transmits a request for a desired service to the selected cell in step 216.

Upon determining that the access is made by the handoff call, the terminal computes a resource price difference ratio DiffRatio_{price} between the currently accessed cell and each candidate cell in step 218. The resource price difference ratio DiffRatio_{price} is computed as a ratio of the resource price in the currently accessed cell and the resource price in the candidate cell. The computation of the resource price difference ratio DiffRatio_{price} can be generalized as shown in Equation (6) below.

$${DiffRatio}_{price} = \frac{{p}_{current} - {p}_{s}}{{p}_{current}} \qquad ( 6 )$$

In Equation (6), p_{current} is the price of resources provided in the currently accessed cell and pₓ is the price of resources provided in the candidate cell. According to Equation (6), the handoff success probability increases as pₓ decreases, and the handoff success probability decreases as pₓ increases.

The resource price difference ratio DiffRatio_{price} of Equation (6) is computed for each candidate cell. In Equation (6), the handoff success probability is determined by only the resource price. In relation to the handoff success probability, although cells for the same service can have different characteristics, the different characteristics are not considered.

In step 220, the terminal obtains a handoff success probability pₛₓ according to a target cell and characteristics of desired service traffic. For this, the probability pₛₓ mapped to each type of service traffic in the target cell should be defined in advance.

In step 222, the terminal computes a probability to be applied for a handoff. The product of the resource price difference ratio DiffRatio_{price} and the probability pₛₓ based on the service traffic characteristics can compute the application probability.

In step 224, the handoff to the target cell is performed on the basis of the computed application probability (DiffRatio_{price}×pₛₓ). As the application probability is high, a probability in which the handoff to the target cell is successful also becomes high. As the application probability is low, a probability in which the handoff to the target cell fails becomes high.

For example, the terminal selects an arbitrary value in a preset range and the handoff for the terminal is performed when the selected value is less than the application probability. As the application probability is high, a handoff attempt probability becomes high. The preset range is defined by upper and lower bound values of the application probability. That is, assuming that the application probability has a value between 0 and 1, a range of selection of the arbitrary value is between 0 and 1.

The operation of FIG. 2 is repeatedly performed until the periodic measurement of strengths of received signals is completed.

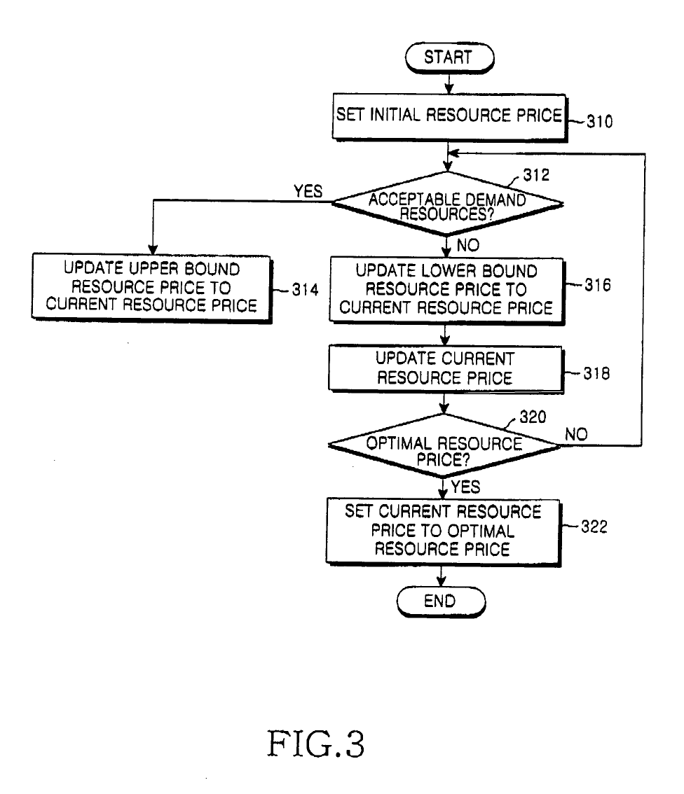

FIG. 3 illustrates a control flow for deciding optimal resource price in a network in accordance with an exemplary embodiment of the present invention. In FIG. 3, there is provided a method for computing resource price for balancing supply and demand resources and providing a service on the basis of the computed resource price. The resource price decreases, when the demand resources are less than the supply resources. The resource price increases, when the demand resources exceed the supply resources. The control flow provided in FIG. 3 can be applied to any one of cells configuring the heterogeneous network and can be applied to all services capable of being provided from a cell.

Referring to FIG. 3, initial resource price is set in a cell in step 310. The initial resource price pᵢₙᵢₜᵢₐₗ is computed using initial upper bound resource price pₘₐₓ and initial lower bound resource price pₘᵢₙ in the cell, and is defined as shown in Equation (7) below.

$${p}_{initial} = \frac{1}{2} ( {p}_{max} + {p}_{min} ) \qquad ( 7 )$$

A determination is made as to whether total resources of the cell can accommodate resources requested for use in step 312. Herein the resources requested for use indicate a sum of resources allocated to a terminal and resources requested for allocation. The resources requested for use can be computed using the number of terminals and an amount of resources required for a desired service. The total resources correspond to a total amount of resources allocated to all services capable of being provided from the cell. The condition in step 312 can be defined as shown in Equation (8) below.

$${\sum }_{s = 1}^{S} {N}_{s} \times {R}_{s} < R \qquad ( 8 )$$

In Equation (8), s is an index for designating a type of service, Nₛ is the number of terminals requesting a particular service, Rₛ is an amount of resources allocated for the particular service, and R is a total amount of resources.

If the above-described condition is satisfied in the cell, the upper bound resource price pₘₐₓ is updated to the current resource price p_{current} in step 314. That is, a range of resource prices decreases. However, if the condition is not the lower bound resource price pₘᵢₙ is updated to the current resource price p_{current} in the cell in step 316. That is, a range of resource prices increases.

As described above, the resource price increases when resources to be allocated are insufficient and decreases when resources to be allocated are sufficient enough.

The network updates the current resource price p_{current} using the updated upper or lower bound resource price pₘₐₓ or pₘᵢₙ in step 318. The current resource price p_{current} is updated by Equation (9) as set forth below.

$${p}_{current} = \frac{1}{2} ( {p}_{max} + {p}_{min} ) \qquad ( 9 )$$

### A determination is made as to whether the updated current resource price is the optimal resource price in the cell in step 320. This is achieved by determining whether the condition of Equation (10) as set forth below is satisfied.

$${\sum }_{s = 1}^{S} {N}_{s} \times {R}_{s} = R \\ or \\ {p}_{max} - {p}_{min} \leq ɛ \qquad ( 10 )$$

The condition of Equation (10) indicates whether an amount of demand resources is equal to an amount of supply resources or whether a resource allocation range (i.e., a difference between the upper and lower bound resource prices) is reduced to a threshold ε.

If the current resource price is not the optimal resource price in the cell as a determination result, an operation for updating the current resource price is repeated in steps 312 to 318. However, if the current resource price is the optimal resource price as the determination result, the updated current resource price p_{current} is set to the optimal resource price p* in the cell in step 322.

According to the above-described operation, the resource price is set to the optimal resource price for balancing demand and supply. This provides the optimal service environment to subscribers, as well as the optimal revenue to network providers. Whenever a new call or a handoff call arrives, the operation for updating the optimal resource price is performed in the cell. When the optimal resource price is updated, the updated price is advertised from the cell to terminals.

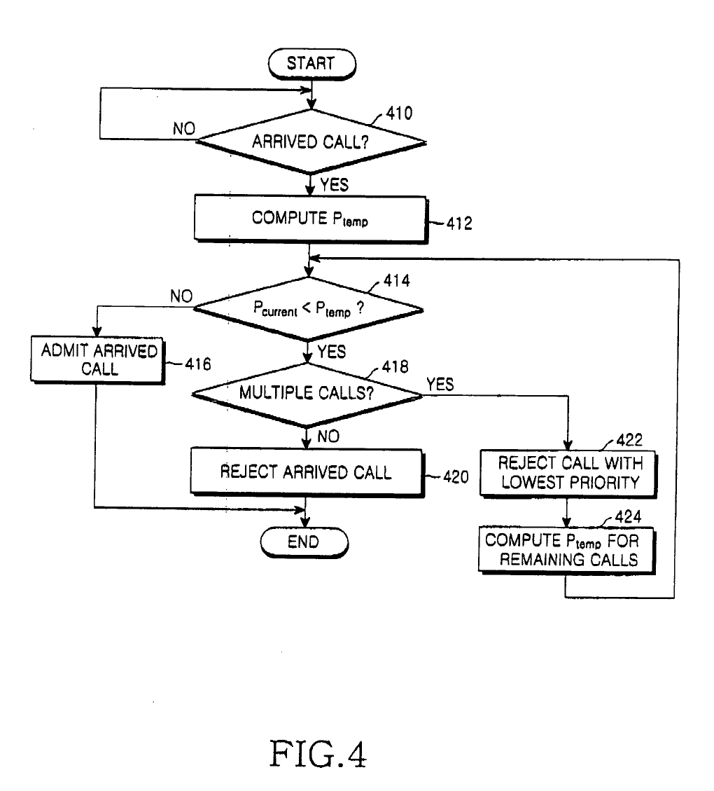

FIG. 4 illustrates a control flow for call admission control in a heterogeneous network in accordance with the present invention. In FIG. 4, there are taken into account a new call, a handoff call without considering mobility, and a handoff call considering mobility. The handoff call without considering mobility is a handoff request from the current cell to another cell for a terminal located in an area where multiple cells can provide a service. The handoff call considering mobility is a handoff request when a terminal moves from the current serving cell to a neighbor cell. In FIG. 4, it is assumed that the handoff call considering mobility is assigned the highest priority and the new call is assigned the lowest priority, in terms of call admission.

Referring to FIG. 4, a determination is made as to whether a call from a terminal has arrived in a cell in step 410. The call from the terminal is divided into a new call and a handoff call. The new call is a call for requesting a new service in the terminal, and the handoff call is a call for requesting a handoff.

If the new call or the handoff call has arrived in the cell, resource price pₜₑₘₚ is computed under assumption that the associated call has been admitted in step 412. That is, the resource price is newly computed by considering resources to be allocated by admitting the arrived call in the previously admitted resources. The computation of the resource price can be limited to a service requested by the terminal.

In step 414, the admission of the arrived call is decided in the cell. The call admission can be decided by determining whether the condition of Equation (11) set forth below is satisfied.

pₜₑₘₚ<p_{current} (11)

That is, if the current resource price p_{current} is more than the newly computed resource price pₜₑₘₚ, the arrived call is admitted in Step 416. Otherwise, the arrived call is rejected.

On the other hand, the cell can be implemented such that call admission or rejection can be decided according to type of the arrived call.

In step 418, a determination is made as to whether multiple calls have arrived in the cell at the same time. If the multiple calls have arrived, the cell can selectively reject the multiple calls.

If only one call has arrived in the cell, the associated call is rejected in step 420. However, if the multiple calls have arrived at the same time, a call with the lowest priority is rejected among the multiple calls in the cell in step 422. In the cell, the handoff call considering mobility is assigned the highest priority. Next, priorities are assigned in order of the handoff call without considering mobility and the new call. That is, the new call is assigned the lowest priority.

In step 424, the resource price pₜₑₘₚ is computed in the cell under assumption that the remaining calls except the call with the lowest priority have been admitted. In step 414, the admission of the remaining calls is decided.

Whenever the new call or the handoff call arrives in the cell, the above-described call admission control operation is performed.

In accordance with the present invention, a terminal using a heterogeneous network can receive a desired service through an optimal cell in terms of resource price, and a network provider can maximize its own revenue.

What is claimed is:

1. A method for processing a call in a terminal of a heterogeneous network, comprising the steps of:
measuring strengths of signals received from cells configuring the heterogeneous network and setting candidate cells;
selecting a candidate cell from among the candidate cells in which a lowest resource price is required for new service traffic when the new service traffic is requested, and transmitting a request for a new call to the selected candidate cell; and
computing a resource price difference ratio between a cell currently providing service traffic and each candidate cell when a handoff is requested for the service traffic, and transmitting a handoff request to one of the candidate cells using the difference ratio and a probability based on characteristics of the service traffic.

2. The method of claim 1, wherein the difference ratio are computed by:
$${DiffRatio}_{price} = \frac{{p}_{current} - {p}_{s}}{{p}_{current}} ,$$
where p_{current} is the price of resources provided in a currently accessed cell and pₛ is the price of resources provided in a candidate cell.

3. The method of claim 1, wherein a probability to be used for the handoff is determined by a product of the difference ratio and the probability based on the characteristics of the service traffic.

4. The method of claim 1, wherein the handoff for the terminal is abandoned when a price of resources provided in a candidate cell exceeds a threshold price.

5. A method for deciding resource prices on a service-by-service basis in cells configuring a heterogeneous network, comprising the steps of:
computing an initial resource price by averaging initial upper and lower bound resource prices defined for each service;
updating the upper bound resource price to a current resource price when demand resources are less than supply resources, and updating the current resource price using the updated upper bound resource price;
updating the lower bound resource price to the current resource price when the demand resources are greater than or equal to the supply resources, and updating the current resource price using the updated lower bound resource price; and
setting the current resource price to an optimal resource price when the demand and supply resources are balanced by the updated current resource price.

6. The method of claim 5, further comprising
setting the current resource price to the optimal resource price when a difference between the upper and lower bound resource prices is reduced below a threshold.

7. A method for processing a call in cells configuring a heterogeneous network, comprising the steps of:
computing a temporary resource price under an assumption that an arrived call has been admitted;
admitting the arrived call when a current resource price is less than or equal to the temporary resource price; and
rejecting the arrived call when the current resource price is greater than the temporary resource price,
wherein when multiple calls have arrived at an identical time, a call with a lower priority is rejected among the multiple calls and admission of the remaining arrived calls is determined.

8. The method of claim 7, wherein a handoff call considering mobility is assigned a highest priority and a new call is assigned a lowest priority.
